(19) United States
(12) Patent Application Publication
(10) Pub. No.: US 2007/0189028 A1
(43) Pub. Date: Aug. 16, 2007

(54) Light emitting warning triangle

(76) Inventor: Kai-Po Chen, Taipei City (TW)

Correspondence Address: LEONG C LEI, PMB # 1008, 1867 YGNACIO VALLEY ROAD, WALNUT CREEK, CA, 94598, US

(21) Appl. No.: 11/354,015

(22) Filed: Feb. 15, 2006

(51) Int. Cl. B60Q 1/26; G08G 1/095; F21S 8/10

(52) U.S. Cl. 362/545; 340/908; 40/541; 362/540

(57) ABSTRACT

A warning triangle mainly contains a stationary side piece, two movable side pieces, a stationary support piece, a movable support piece, a battery chamber, circuit boards, and light emitting diodes (LEDs) to achieve superior visibility. Grooves are provided on the two sides and along the outer edges of the side pieces, and a circuit board with distributed LEDs is positioned inside each of the grooves and driven by the battery chamber.

### BACKGROUND OF THE INVENTION

(a) Technical Field of the Invention

The present invention generally relates to warning triangles, and more particularly to a warning triangle having built-in light emitting diodes.

(b) Description of the Prior Art

Usually a warning triangle is set up at an appropriate distance along the road behind a broken-down automobile to warn oncoming drivers about the potential hazard ahead.

The three sides of a warning triangle are usually separable for easy storage in the trunk of the automobile. When setting up the warning triangle, its three sides are usually pin-joined at their ends with each other and the triangular sign thus formed is positioned on a sturdy stand. Reflection plates are affixed to the three sides of the warning triangle, and the inner planes of the reflection plates are saw-toothed for enhanced reflectivity.

Some manufacturers install lamps in front of the saw-toothed, reflective inner planes inside the reflection plates, in the hope of increasing the warning triangle's visibility. Within a short distance, the visibility is indeed increased as the light of the lamps are also reflected by the inner planes of the reflection plates. However, at a farther distance from the warning triangle, the visibility actually decreases as the reflectivity of the reflection plates are impaired by the lamps blocking the light incident onto the inner planes.

### SUMMARY OF THE INVENTION

The primary purpose of the present invention is to provides a warning triangle which resolves the foregoing shortcomings of conventional warning triangles. The present invention mainly contains a stationary side piece, two movable side pieces, a stationary support piece, a movable support piece, a battery chamber, circuit boards, and light emitting diodes (LEDs) to achieve superior visibility.

A major aspect of the present invention is that grooves are provided on the two sides and along the outer edges of the side pieces, and a circuit board with distributed LEDs is positioned inside each of the grooves and sealed by a transparent cover.

Another major aspect of the present invention is that the circuit board can be positioned on both sides of the side pieces, or on one of the sides only. Therefore the warning triangle of the present invention can be used to alert drivers from both ways of the road, or just from one of the directions.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing the various components of a warning triangle according to an embodiment of the present invention.

FIG. 2 is a perspective view showing the warning triangle of FIG. 1 with its support pieces folded.

FIGS. 3A, 3B, 3C is a sectional view showing the warning triangle of FIG. 2, along with details of the side pieces.

FIG. 4 is a side view showing the warning triangle of FIG. 2.

FIG. 5 is a perspective view showing the warning triangle of FIG. 1 when it is completely folded.

FIG. 6 is a perspective view showing how the warning triangle is unfolded from the folded state of FIG. 5.

FIGS. 7A, 7B is a sectional view showing a warning triangle according to another embodiment of the present invention, along with details of the side pieces.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

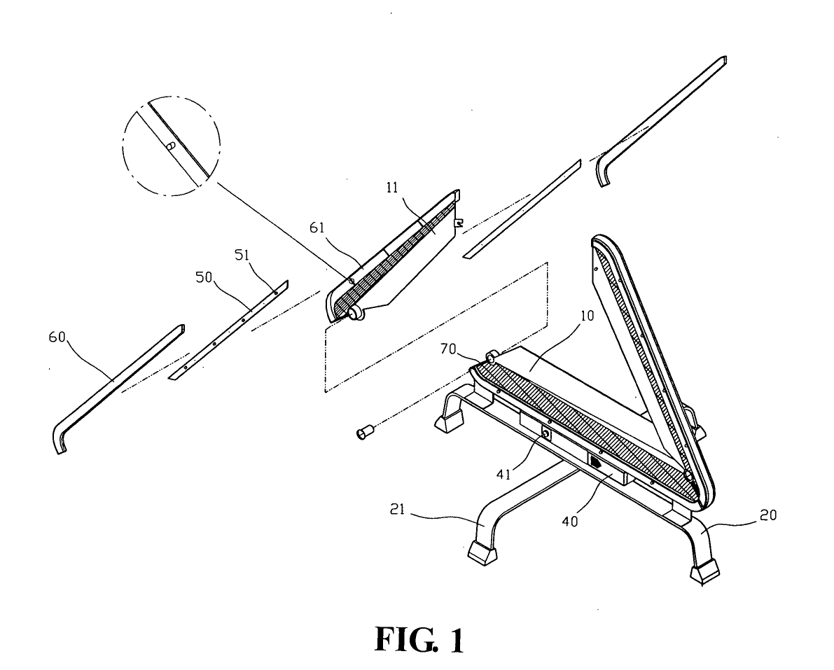

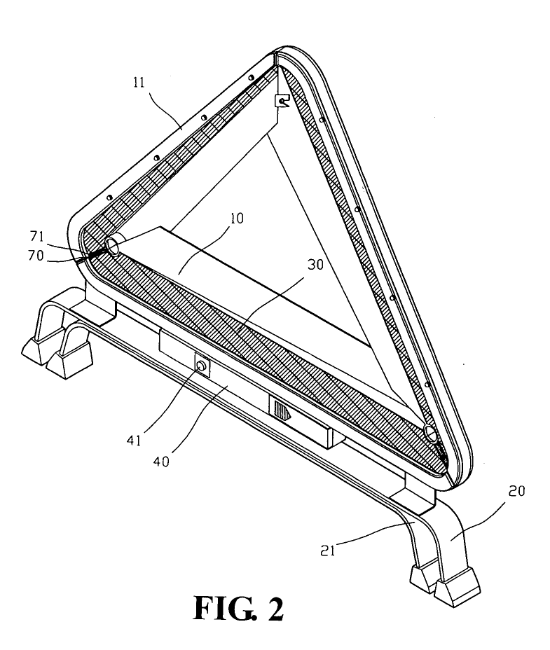

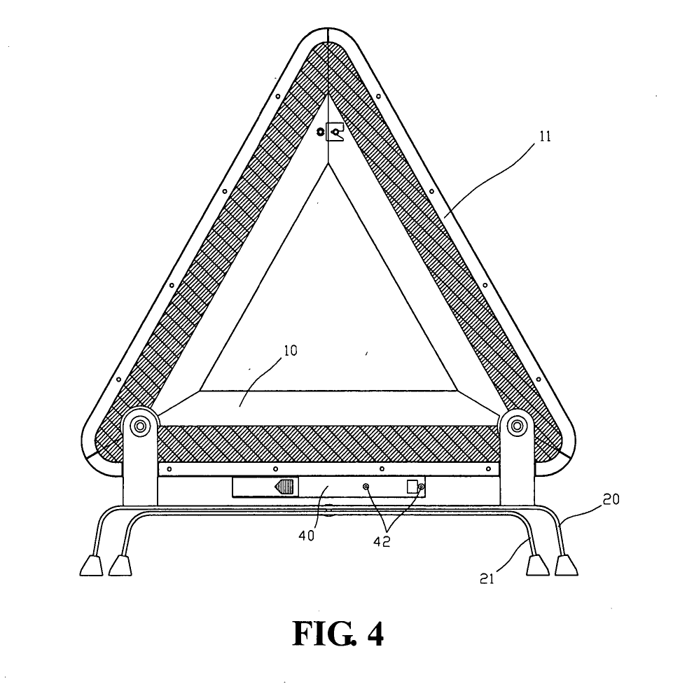

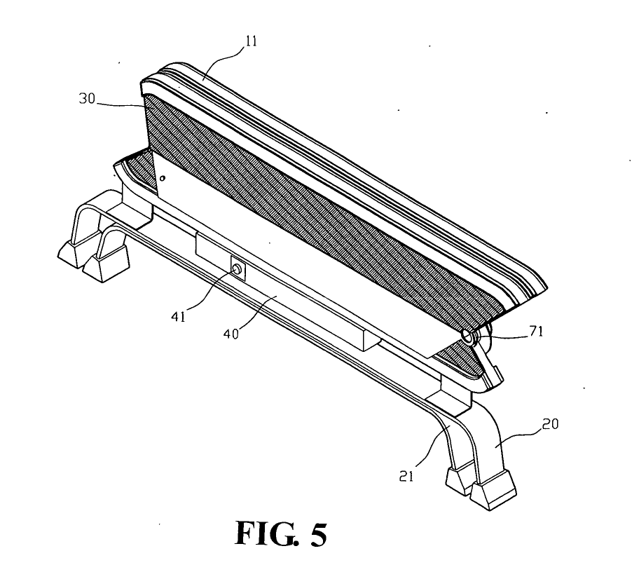

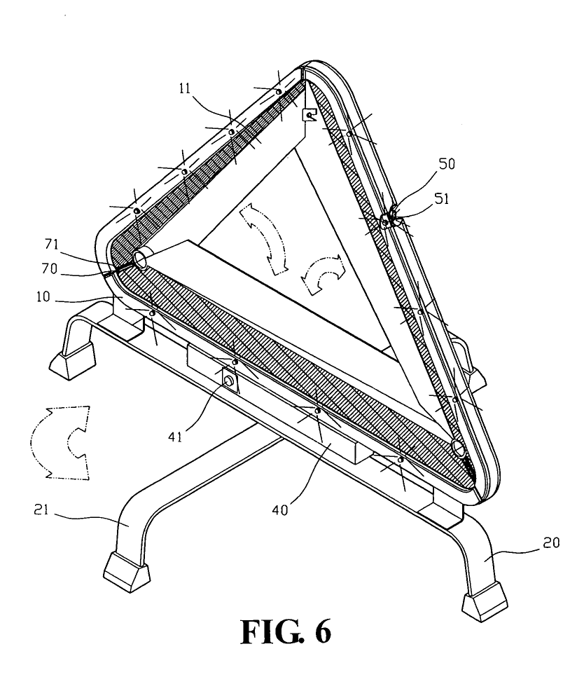

As shown in FIGS. 1 to 6, the warning triangle according to an embodiment of the present invention contains a stationary side piece 10, two movable side pieces 11, a stationary support piece 20, a movable support piece 21, a battery chamber 40, circuit boards 50, and light emitting diodes (LEDs) 51.

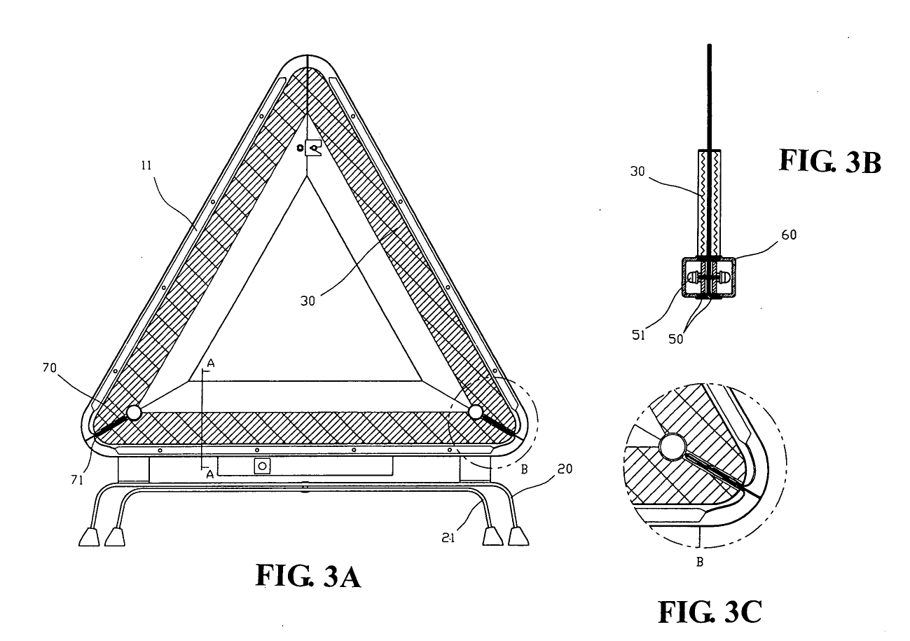

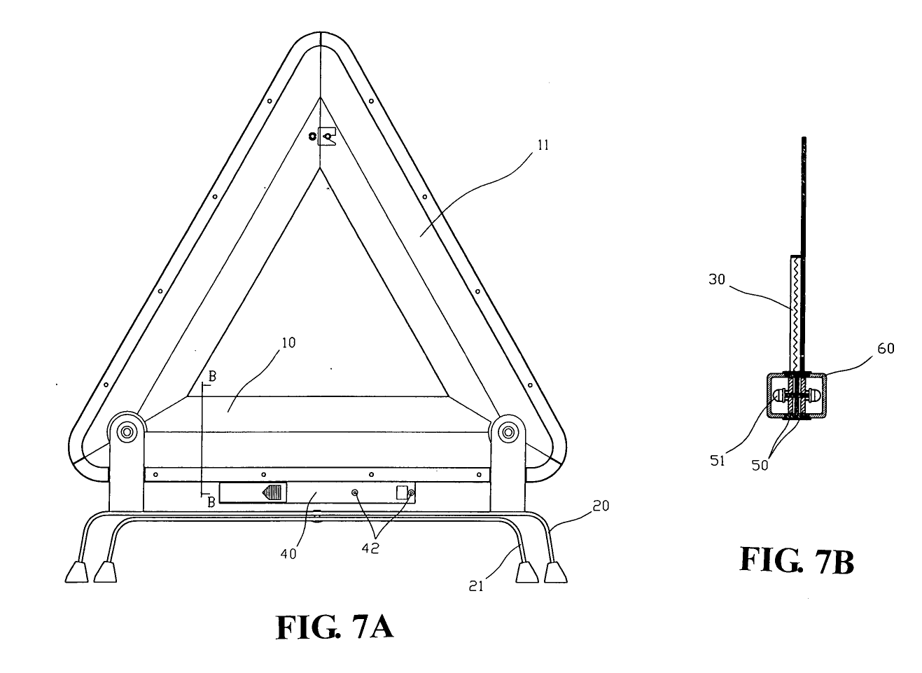

The stationary side piece 10, as the bottom side of the warning triangle, is fixedly attached the stationary support piece 20. The two movable side pieces 11 have one of their ends pin-joined to and thereby can pivot around the two ends of the stationary side piece 10 respectively. As the two movable side pieces 11 are at an appropriate included angle with the stationary side piece 10, the other ends of the movable side pieces 11 can be joined together to complete the triangular shape of the warning triangle. Reflection plates 30 of compatible shapes to the side pieces 10 and 11 are provided on the two sides of the side pieces 10 and 11. Grooves 61 are provided on the two sides and along the outer edge of each of the side pieces 10 and 11. A circuit board 50 having distributed LEDs 51 is placed inside each groove 61, as shown in FIG. 1 and in the cross-sectional view along the A-A line in FIGS. 3A, 3B & 3C. Atransparent cover 60 is then used to seal the groove 61. Please note that, in an alternative embodiment, the reflection plates can be provided on a single side of the side pieces 10 and 11 only, as shown in FIGS. 7A & 7B. The number and color of the LEDs 51 and how they are flashed can be varied according to the application. The movable support piece 21 is pin-joined to the stationary support piece 20 so that they can be folded together, or unfolded to become perpendicular with each other to provide steady support to the triangle formed by the side pieces 10 and 11.

The battery chamber 40 housing a number of, say, AAA batteries, is positioned between the stationary side piece 10 and support piece 20, and provides electricity to the circuit boards 50 and the LEDs 51. The present embodiment can also be powered by the 12V˜24V DC voltage of the car battery by appropriate electrical connection through the sockets 42. There is also a power switch 41 for turning on and off of the warning triangle. When the present embodiment is turned on, the LEDs 51 will be flashed by the circuit boards 50 for enhanced visibility. Conduction wires 71 are extended from the battery chamber 40 to the circuit boards 50 of the two movable side pieces 11. At where the stationary side piece 10 and the two movable side pieces 11 meet, the side piece 10 and the movable side pieces 11 all have appropriate wire ducts 70 allowing the conduction wires 71 to pass through.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A warning triangle, comprising
a stationary side piece and two movable side pieces, said two movable side pieces having one of their ends pin-joined to and thereby being able to pivot around the two ends of said stationary side piece respectively to have their other ends joined together to complete a triangular shape, a reflection plate being provided on at least one side of each of said stationary and movable side pieces, a groove being provided on at least one side and along the outer edge of each of said stationary and movable side pieces;
a stationary support piece and a movable support piece flexibly joined together that can be folded and unfolded, said stationary side piece being fixed attached to said stationary support piece;
a plurality of circuit boards, each of which having a plurality of light emitting diodes, and being housed in one of said grooves of said stationary and movable side pieces; and
a battery chamber housing at least a battery to provide electricity to said circuit boards via appropriate electrical connection.
